(19) United States
(12) Patent Application Publication
(10) Pub. No.: US 2004/0054010 A1
(43) Pub. Date: Mar. 18, 2004

(54) Endosulfan formulation and methods of use thereof

(76) Inventors: Tara D. Sutherland, Watson (AU); Michael J. Lacey, Hughes (AU); Robyn J. Russell, Wanniassa (AU); John G. Oakeshott, Waqnniassa (AU)

Correspondence Address: FOLEY AND LARDNER, SUITE 500, 3000 K STREET NW, WASHINGTON, DC, 20007, US

(21) Appl. No.: 10/415,941

(22) PCT Filed: Nov. 20, 2001
(86) PCT No.: PCT/AU01/01505

(30) Foreign Application Priority Data
Nov. 20, 2000 (AU) PR 1584

(51) Int. Cl. A01N 41/06

(52) U.S. Cl. 514/602

(57) ABSTRACT

The present inventors have found that the contrasting chemical, physical and environmental characteristics of alpha and beta endosulfan provide an opportunity to formulate an effective endosulfan formulation with lower risk to the environment. Accordingly, the present invention provides a method for controlling or reducing pest numbers in an area affected or likely to be affected by pests, the method comprising applying to the area an endosulfan formulation, the formulation comprising beta endosulfan and alpha endosulfan, wherein the ratio of beta to alpha endosulfan in the formulation is at least 3.5:6.5 w/w.

### FIELD OF THE INVENTION

This invention relates to an improved method for reducing the numbers of pests in an area, and in particular, to an improved formulation comprising endosulfan (6,7,8,9,10,10-hexachloro-1,5,5a,6,9,9a-hexahydro-6,9-methano-2,4,3-benzodioxathiepin-3-oxide) as an active ingredient, as well as its application in controlling pest infestation in agriculture.

### BACKGROUND TO THE INVENTION

Endosulfan is a broad-spectrum pesticide that has been used extensively for over 30 years on a variety of crops. It is especially useful because it is “soft” on beneficial insects and it is one of the few remaining organochlorine pesticides available for use in resistance management. However, contamination of aquatic environments as a result of run-off from arable soils is of major concern because of the high toxicity of this pesticide towards fish. Additionally, while endosulfan itself has relatively low persistence, the toxic metabolite endosulfan sulfate can accumulate in animal fat. As a result, pasture and drinking water contamination can result in unacceptably high endosulfan sulfate levels in locally grown production animals. These residue problems have been increasingly recognised in the last decade. In contrast, endosulfan was developed as an pesticide over 30 years ago and thus the bulk of the research supporting its development did not specifically address the problems associated with the pesticide today.

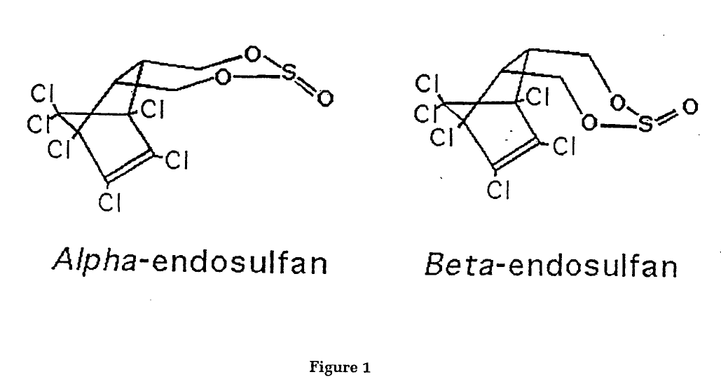

Commercial endosulfan is synthesised by esterification and cyclisation of endosulfan diol with thionyl chloride. This forms a mixture of two stereoisomers comprising approximately 70% alpha- and 30% beta-endosulfan (FIG. 1). These two isomers differ in their chemical properties, physiological effects and behavior in the environment, and as a result do not contribute equally to residues problems associated with the pesticide.

Oxidation of either isomer produces the same compound, endosulfan sulfate, which has similar toxicity to the parent compound. Oxidation of endosulfan is a widespread biological phenomenon and generally endosulfan sulfate is the predominant residue detected after exposure of biological systems to the pesticide. There is no evidence that this metabolite forms spontaneously in the environment. Endosulfan sulfate is chemically more stable than the parent compound and this is reflected in greater persistence in the environment.

The chemical and physical properties of α- and β-endosulfan are significantly different. The volatility of α-endosulfan has been demonstrated repeatedly to be higher than the β-isomer (Beard and Ware, 1969; Archer et al., 1972; Archer, 1973; Goebel et al., 1982; Singh et al., 1991). This characteristic is especially important considering that within two days of field application, during the Australian cotton growing season, 70% of endosulfan is lost through volatilisation (Kennedy et al., 1998a, b). Because of the high volatility of the a-endosulfan it is only found in soils at appreciable levels immediately after spraying (Kaphpal et al., 1997). The half-lives of a- and, endosulfan on the upper leaves of cotton plants has been measured at 12 hours and 36 hours respectively after spray application in hot conditions (average max. temp was 40° C. for 48 hours after spray) and 24 hours and 60 hours under milder conditions (temperature not reported) (Edge et al., 1998).

Chemical hydrolysis of either isomer produces the same product, endosulfan diol. This reaction is recognised as detoxifying the pesticide since endosulfan diol does not appear to have significant toxicity in any biological system and the compound is readily degraded by a range of organisms. The beta-isomer is approximately 25% more vulnerable to chemical hydrolysis than the alpha-isomer at neutral and alkali pH and over twice as susceptible to photolysis (Singh et al., 1991).

Biological hydrolysis to endosulfan diol has been described in numerous systems, and hydrolysis to endosulfan monoaldehyde has been reported in soil bacteria. Sutherland et al. (2000) compared the rates of biological hydrolysis in a soil bacterial culture and found that hydrolysis of the beta-isomer occurred at significantly higher rates than hydrolysis of the alpha-isomer.

Beta-endosulfan dissipates more rapidly than the alpha-isomer in sealed aqueous media. In contrast, the alpha-isomer dissipates faster in an unsealed environment as beta-isomer is more prone to chemical hydrolysis and alpha-isomer is more susceptible to volatilisation. In a sealed container the latter difference would be diminished.

Endosulfan is metabolised on the surface of plants to endosulfan sulfate and invariably this metabolite is the major residue detected after exposure to the pesticide. There is no evidence for transport of the isomers or metabolite in any substantial amount within the vascular system. The alpha-isomer of endosulfan dissipates more rapidly than the beta-isomer. This has been partially attributed to the higher volatility of the alpha-isomer, and partially to its susceptibility to oxidize on the surface of the plant. Studies measuring rates of endosulfan sulfate formation on plants exposed to the individual isomers found that formation of endosulfan sulfate from the alpha-isomer was rapid whereas oxidation of the beta-isomer was considerably slower. This preferential formation of endosulfan sulfate from alpha endosulfan is particularly important as this metabolite is usually the only residue detected in production animals exposed to the pesticide as a result of inadequately controlled endosulfan application.

In mammals endosulfan is acutely toxic and has also been found to induce neurotoxicity, renal toxicity, hepatotoxicity, haematologic toxicity, respiratory toxicity and reproductive toxicity. A comparison of the acute toxicity of the isomers and the metabolite endosulfan sulfate after ingestion by rats and mice is shown in Table 1. Both the alpha-isomer and endosulfan sulfate have acute toxicities approximately four fold higher than the beta-isomer. Most studies investigating the chronic toxicity of endosulfan in mammals have not differentiated between the isomers. An exception is the neurotoxic action of endosulfan that has been attributed to the alpha-isomer.

TABLE 1
The acute toxicity of the isomers of endosulfan and
endosulfan sulfate in mammals.

| | LD₅₀ (mg · kg⁻¹) | | | |
|---|---|---|---|---|
| | alpha- | beta- | | |
| | endosulfan | endosulfan | endosulfan sulfate | Reference |
| Rats | 76 | 240 | 76 | Goebel et al., 1982 |
| Mice | 11 | 36 | 8 | Dorough et al., |
| | | | | 1978 |

Previous comparative studies of the effect of the individual isomers of endosulfan on insects have found that the alpha-isomer rather than the beta-isomer is more toxic to insects (Table 2). These studies involved topical application of the isomers in acetone or relied on volatilisation of the isomers from surfaces in closed containers.

TABLE 2
Comparative effects of the isomers of endosulfan and
endosulfan sulfate on insects.

| Species and mode of | alpha- | beta- | endosulfan | |
|---|---|---|---|---|
| application | endosulfan | endosulfan | sulfate | Reference |
| Musca domestica | | | | |
| (house fly) | | | | |
| Topical application | | | | |
| in acetone | | | | |
| LD₅₀ (μg · g⁻¹) | 5.5 | 9.0 | 9.5 | Barnes and |
| | | | | Ware, 1965 |
| (μg · fly⁻¹) | 0.14 | 0.19 | — | Lindquist and |
| | | | | Dahm, 1957 |
| Helicoverpa zea | 630 | 4140 | 820 | Walfenbarger |
| Topical application | | | | and Guerra, |
| in acetone | | | | 1972 |
| LD₅₀ (μg·g⁻¹) | | | | |
| Heliothis virescens | high* | 4960 | high* | Walfenbarger |
| Topical application | | | | and Guerra, |
| in acetone | | | | 1972 |
| LD₅₀ (μg·g⁻¹) | | | | |

*20-36% mortality at 680 mg · kg⁻¹, not able to calculate LD₅₀.

Contrary to the above data the present inventors have found the surprising result that a beta-enriched endosulfan formulation is as efficacious under field conditions as commercial endosulfan (approximately 70% alpha/30% beta). Additionally, the present inventors provide a simple method for the preparation of a beta-enriched product.

### SUMMARY OF THE INVENTION

The present inventors have found, contrary to previous evidence, that beta-endosulfan has similar levels of efficacy as an pesticide to that of alpha-endosulfan. The alpha- and beta-isomers, however, do not contribute equally to residue problems associated with endosulfan. After application, alpha-endosulfan dissipates by volatilisation or is oxidised on the surface of plants or in the soil to the toxic metabolite endosulfan sulfate. Endosulfan sulfate accumulates in the fat of animals and so is generally the only residue detected in “endosulfan-contaminated” production animals. Conversely beta-endosulfan is more persistent on the plant surface and is more prone to hydrolysis to the non-toxic endosulfan diol in comparison to the alpha-isomer.

The present inventors viewed the contrasting chemical, physical and environmental characteristics of alpha and beta endosulfan as indicating an opportunity to formulate an effective endosulfan formulation with lower risk to the environment.

Accordingly, in a first aspect the present invention provides a method for controlling or reducing pest numbers in an area affected or likely to be affected by pests, the method comprising applying to the area an endosulfan formulation, the formulation comprising beta endosulfan and alpha endosulfan, wherein the ratio of beta to alpha endosulfan in the formulation is at least 3.5:6.5 w/w.

Ultra low volume (ULV) endosulfan formulations are desirable as large amounts of water are not required for the formulations, rapid evaporation of water in emulsion formulations can result in uneven coverage, and there are advantages in generally dealing with smaller volumes. However, ultra low volume formulations have the disadvantage of being prone to greater drift upon spraying an area, increasing the buffer zones required between the area sprayed and other areas containing, for example, domestic animals. For this reason, currently available ULV endosulfan formulations cannot be used in Australia. Contamination of pastures and/or drinking water by spray drift as a result of ULV application of endosulfan formulations of the present invention will produce lower levels of endosulfan sulfate, hence endosulfan residue levels in production animals consuming such pastures/water will be reduced. The present invention increases the attractiveness of producing, and using, an ultra low volume endosulfan formulation as beta endosulfan is generally more readily hydrolysed to non-toxic endosulfan diol and less prone to oxidation when compared to alpha endosulfan.

Accordingly, in a preferred embodiment of the present invention, the formulation is an ultra low volume formulation. Preferably, the ultra low volume formulation comprises a low volatility solvent. Preferably, the low volatility solvent is selected from the group consisting of, mineral oils, vegetable oils, and aromatic hydrocarbons. In addition, is it preferred that the formulation further comprises an emulsifier and/or a stabilizer. Preferably, the emulsifier is selected from the group consisting of nonionic surfactants and anionic surfactants. Preferred nonionic surfactants include alkylphenolalkoxylates (such as nonylphenolethoxylates), castor oil alkoxylates, vegetable oil alkoxylates, fatty amine alkoxylates, fatty alcohol alkoxylates and alkoxylated alkylphenol. Preferred anionic surfactants include alkylaryl sulfonate calcium salt (e.g. calcium dodecylbenzenesulfonate), fatty alcohol phosphate ester, free acid form, and alkanolamine salt of dodecylbenzene sulfonate. Preferably, the stabilizer is epoxidised soybean oil.

Although the endosulfan formulations of the present invention can take many forms, including the above-mentioned ULV formulations, it is also preferred that the formulation is an emulsified concentrate (EC) that needs to be diluted in water before use, wherein the concentrate comprises an emulsifier and a solvent. Preferably, the emulsifier is selected from the group consisting of nonionic surfactants and anionic surfactants. Preferred nonionic surfactants include alkylphenolalkoxylates (normally nonylphenolethoxylates), castor oil alkoxylates, vegetable oil alkoxylates, fatty amine alkoxylates, fatty alcohol alkoxylates and alkoxylated alkylphenol. Preferred anionic surfactants include alkylaryl sulfonate calcium salt (e.g. calcium dodecylbenzenesulfonate), fatty alcohol phosphate ester, free acid form, and alkanolamine salt of dodecylbenzene sulfonate. In a further preferred embodiment, the emulsified concentrate comprises an anionic surfactant and at least one nonionic surfactant. Further, it is preferred that the solvent is an aromatic hydrocarbon.

Ultra low/emulsifiable concentrate (UL/EC) formulations allows growers to apply the same product from ground rigs (applied in water as an EC) early in the season, and from aircraft (applied neat as a ULV) later in the season, when ground rigs are no longer able to enter the paddocks.

Accordingly, in a further preferred embodiment, the endosulfan can also be in the form of an ultra low/emulsifiable formulation. Such UL/EC formulations comprise an emulsifier, and a low volatility solvent. The emulsifier can be selected from the group consisting of alkyl phenol ethoxylate and calcium dodecyl benzene sulfonate. The low volatility solvent can be selected from the group consisting of mineral oil, vegetable oil and aromatic hydrocarbons. Preferably, the UL/EC formulation further comprises a stabilizer. Preferably, the stabiliser is epoxidised soybean oil.

Due to the high volatility of alpha endosulfan, it is considered that it is not viable to apply available endosulfan formulations (approximately 70% alpha and 30% beta endosulfan) to an area when temperatures are high, as hat is thought to be the main active ingredient, namely alpha endosulfan, rapidly evaporates. For example, the half-lives of α- and β-endosulfan on the upper leaves of cotton plants have been measured at 12 hours and 36 hours respectively after spray application in hot conditions (average max. temp was 40° C. for 48 hours after spray (Edge et al., 1998)). The formulations and methods of the present invention have increased percentages of beta endosulfan which is significantly less volatile than alpha endosulfan, allowing the method of the present invention to be used during hot periods.

Accordingly, in a further embodiment of the present invention, the air and/or ground temperature of the area to which the formulation is to be applied is at least 28° C., alternatively at least 30° C., alternatively at least 35° C., alternatively at least 40° C., or alternatively at least 45° C.

Seventy percent of applied endosulfan (as currently available, namely approximately 7:3 alpha to beta endosulfan) is lost within 2 days of application. Most of this loss in through evaporation of the alpha isomer (Kennedy et al., 1998a, b). The present inventors have found that efficacy is not compromised at lower application rates with beta endosulfan enriched formulations. Therefore equivalent efficacy can be achieved with reduced application rates of a beta endosulfan enriched formulation.

As such, in yet another embodiment the endosulfan formulation is applied at less than 1000 gai/ha (grams active ingredient per hectare), alternatively less than 750 gai/ha, alternatively less than 500 gai/ha, alternatively less than 400 gai/ha, or alternatively less than 250 gai/ha.

In a preferred embodiment of the present invention, the ratio of beta to alpha endosulfan is at least 4:6 w/w, more preferably at least 5:5 w/w, even more preferably at least 6:4 w/w, even more preferably at least 7:3 w/w, even more preferably at least 8:2 w/w, even more preferably at least 9:1 w/w, and more preferably at least 19:1 w/w.

In yet another embodiment, the ratio of beta to alpha endosulfan is between 4:6 and 99:1 w/w, more preferably between 9:1 and 99:1 w/w, more preferably between 9:1 and 19:1 w/w.

Typically, the area will comprise commercially important plants. Therefore, in a another embodiment, the area comprises a food or cash crop. Examples of food crops generally include fodder, vegetables, fruits, oilseeds and cereals crops. Examples of cash crops include sugar-cane, cotton, ornamentals, tea, and tobacco. Preferably, the area comprises vegetables, fruits, tobacco or cotton.

Preferably, the pest is a species of Insecta or Acarina. More preferably, the species of Insecta is a lepidopteran, hemipteran, dipteran, hymenopteran, isopteran, homopteran, heteropteran, thysanopteran or coleopteran. Most preferably, the species of Insecta is a Heliothis sp., Helicoverpa sp. or an aphid. Preferably, the species of Acarina is a mite. More preferably, the mite is the red legged earth mite or the blue oat mite.

In a second aspect, the present invention provides a method for controlling or reducing pest numbers in an area affected or likely to be affected by pests, the method comprising applying to the area an endosulfan formulation, the formulation comprising beta endosulfan but no alpha endosulfan.

Cyclodiene pesticides inhibit GABA-induced chloride flux across membranes through the GABA-gated chloride channel and consistent with this site of action, cyclodiene resistance in pests is associated with a single point mutation in the GABA receptor that confers target site insensitivity. The α-endosulfan is much more potent at inhibiting the GABA-induced chloride flux than the,-isomer (Abalis et al., 1985; Abalis et al., 1986; Gant et al., 1987). The isomers of endosulfan have different chemical and physical properties and therefore it is considered that they may have different modes of action. Resistance in pests is target site resistance that has evolved to the predominantly alpha endosulfan based pesticide. Therefore pests resistant to the current commercially available pesticide may still be susceptible to a beta endosulfan based pesticide.

Therefore, in a third aspect, the present invention provides a method for controlling or reducing pest numbers in an area affected or likely to be affected by pests, the method comprising applying to the area an endosulfan formulation, the formulation comprising beta endosulfan and alpha endosulfan, wherein the ratio of beta to alpha endosulfan in the formulation is at least 3.5:6.5 w/w, and wherein at least some of the pests are resistant to endosulfan formulations wherein the ratio of beta to alpha endosulfan in the formulation is equal to or less than about 3:7 w/w.

In a fourth aspect, the present invention provides a method for controlling or reducing pest numbers in an area affected or likely to be affected by pests, the method comprising applying to the area an endosulfan formulation, the formulation comprising beta endosulfan but no alpha endosulfan, wherein at least some of the pests are resistant to endosulfan formulations wherein the ratio of beta to alpha endosulfan in the formulation is equal to or less than about 3:7 w/w.

As used herein, the term “resistant” refers to the relative responses of genetically-defined pest populations to endosulfan. These responses include feeding, reproduction rates and survival. The absolute doses that define susceptibility and resistance vary with the pest species and genetically defined populations examined, and the method of exposure. In general, a pest strain or population is considered “resistant” if it exhibits tolerance to endosulfan (assessed as the dose required to affect feeding or reproduction or survival in 50% of a treated population or group) that is at least 10 times greater than the tolerance of an appropriate reference, or “susceptible” population.

In a fifth aspect the present invention provides an endosulfan formulation, the formulation comprising beta endosulfan and alpha endosulfan, wherein the ratio of beta to alpha endosulfan in the formulation is at least 3.5:6.5 w/w.

In a preferred embodiment of the fifth aspect the ratio of beta to alpha endosulfan is at least 4:6 w/w, more preferably at least 5:5 w/w, even more preferably at least 6:4 w/w, even more preferably at least 7:3 w/w, even more preferably at least 8:2 w/w, even more preferably at least 9:1 w/w, and more preferably at least 19:1 w/w.

In another embodiment of the fifth aspect, the ratio of beta to alpha endosulfan is between 4:6 and 99:1 w/w, more preferably between 9:1 and 99:1 w/w, more preferably between 9:1 and 19:1 w/w.

Commercial endosulfan is synthesised by esterification and cyclisation of endosulfan diol with thionyl chloride which produces a mixture comprising approximately 70% alpha- and 30% beta-endosulfan. The inventors have also devised a method for separating beta endosulfan from such mixtures.

Accordingly, in a sixth aspect, the present invention provides a method of enriching the beta endosulfan content of a mixture containing alpha endosulfan and beta endosulfan comprising:

(a) providing a solution of the mixture in a solvent;

(b) cooling the solution to a temperature at which at least part of the beta endosulfan precipitates to form a crystalline product comprising the precipitated beta endosulfan and a supernatant solution;

(c) separating the crystalline product from the supernatant solution; and

(d) optionally washing the crystalline product.

Preferably, the ratio of beta endosulfan to alpha endosulfan in the mixture of step (a) is less than 1:1 w/w and the ratio of beta endosulfan to alpha endosulfan in the crystalline product in step (c) is at least 1:1 w/w.

Preferably, the ratio of beta endosulfan to alpha endosulfan of the mixture in step (a) is about 3:7 w/w.

Further, it is preferred that the ratio of beta endosulfan to alpha endosulfan in the crystalline product of step (c) is at least 3.5:6.5 w/w.

To further enhance the purity of the beta endosulfan crystals the method can be repeated.

In a seventh aspect, the present invention provides a crystalline substance comprising beta endosulfan and alpha endosulfan in a ratio of at least 3.5:6.5 w/w.

Preferably, the ratio of beta to alpha endosulfan of the crystalline substance is at least 4:6 w/w, more preferably at least 5:5 w/w, even more preferably at least 6:4 w/w, even more preferably at least 7:3 w/w, even more preferably at least 8:2 w/w, even more preferably at least 9:1 w/w, and more preferably at least 19:1 w/w.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The invention is hereinafter described by way of the following non-limiting example and with reference to the accompanying figures.

### DETAILED DESCRIPTION OF THE INVENTION

In order that the nature of the present invention may be more clearly understood preferred forms thereof will now be described with reference to the following Figures in which:

FIG. 1. shows the stereochemistry of the isomers of endosulfan.

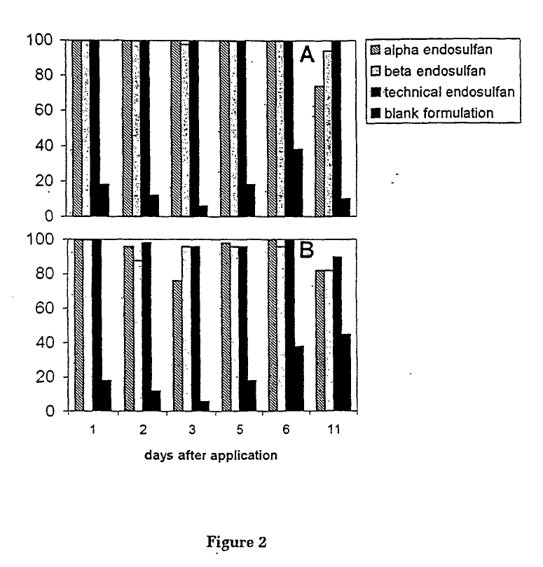

FIG. 2. shows persistence of the acute toxicity of various endosulfan formulations towards Helicoverpa larvae. Sicot 50 plants, grown in the field at Narrabri NSW, Australia, were sprayed until runoff with 0.5% (A) and 0.25% (B) active ingredient endosulfan formulations or with blank formulation. Treatments were: alpha-endosulfan (85% alpha-isomer: 15% beta-isomer); beta-endosulfan (95% beta-isomer: 5% alpha-isomer); commercial endosulfan (THIODAN—Aventis CropScience Pty Ltd—70:30 w/w alpha to beta endosulfan); blank formulation (no active ingredient). Formulations were prepared to mimic the formulation of the commercial pesticide. Leaves (10) from each treatment were picked at various days after endosulfan application and provided to 5 first instar Helicoverpa larvae. Leaves were kept in agar tubs to retain leaf quality and after 4 days at 25° C. the survival rates of the larvae was determined.

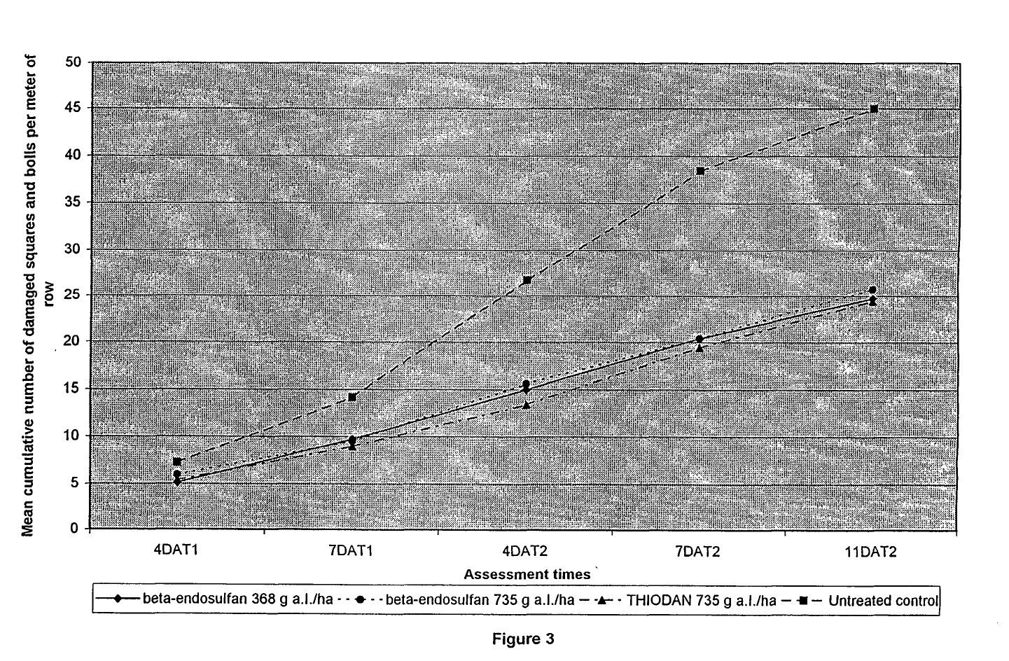

FIG. 3. Crop damage by Helicoverpa larvae following treatment with various endosulfan formulations. 4DAT1=4 days after treatment 1, 7DAT1=7 days after treatment 1, 4DAT2=4 days after treatment 2, 7DAT1=7 days after treatment 2, and 11DAT1=11 days after treatment 2.

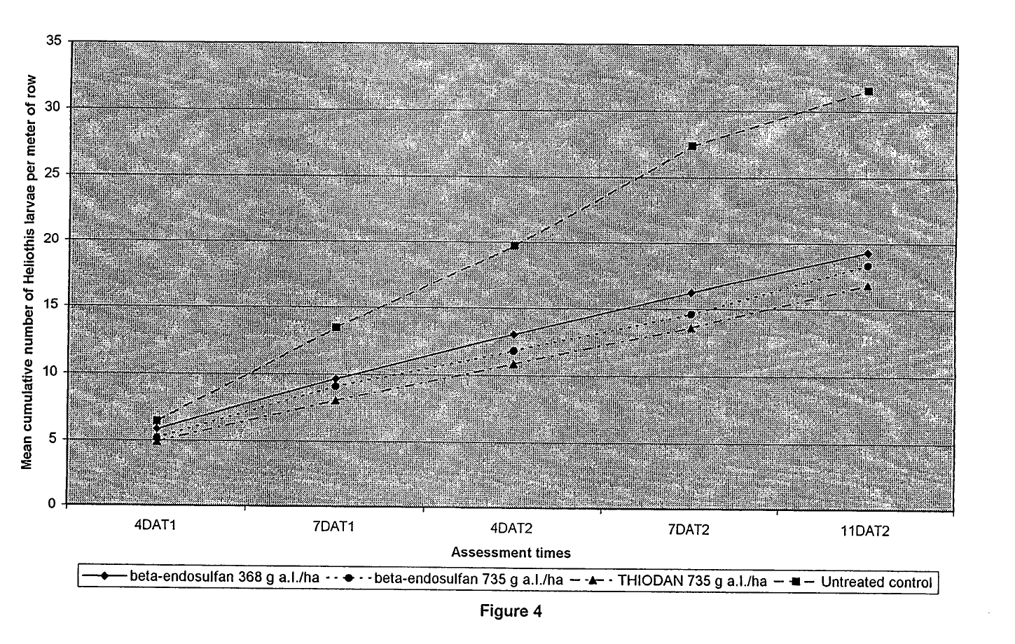

FIG. 4. Number of Helicoverpa larvae following treatment with various endosulfan formulations. 4DAT1=4 days after treatment 1, 7DAT1=7 days after treatment 1, 4DAT2=4 days after treatment 2, 7DAT1=7 days after treatment 2, and 11DAT1=11 days after treatment 2.

### ENDOSULFAN FORMULATIONS

The endosulfan formulations of the present invention can be prepared using techniques known in the art. Generally, the formulation is prepared such that the endosulfan can be delivered to the pest by ingestion and/or contact.

Technical grade endosulfan is a brown crystalline substance consisting of alpha and beta isomers in the ratio of approximately 70:30, and has a purity of about 94 to 99%.

Many formulations containing endosulfan are commercially available. Pesticide manufacturers make use of various inert ingredients (such as alcohol solvent emulsifiers; petroleum distillate emulsifiers; suspension agents, water, clay, and wetting agents; and talc) to produce these formulations. In general, commercially available formulations are purchased by the consumer as an emusifiable concentrate (typically about 35% endosulfan w/v) or as ULV formulations (typically about 25% endosulfan w/w). However, endosulfan is also available in other forms including as a wettable powders, aqueous suspensions, dusts, granules and baits.

Emulsifiable concentrates can at least contain between 15 and 40% active agent mixed with an emulsifier and a suitable solvent. Commercially available formulations are typically diluted in water by the consumer before use to a concentration around 0.5% endosulfan which forms an oil-in-water emulsion that is usually applied as a spray. In one example, an endosulfan emulsified concentrate contains (figures for 1 L of concentrate) 350 g/L of technical grade endosulfan (99% purity), 37 g of alkyl phenol ethoxylate and 33 g of calcium dodecyl benzene sulfonate as emulsifiers, with the balance being an aromatic hydrocarbon as solvents. A further example of an oil-in-water endosulfan emulsion is provided U.S. Pat. No. 5,531,995 which discloses a formulation comprising 190 g/l to 350 g/l endosulfan, 150 g/l to 400 g/l of the methyl ester of rosin; 30 g/l to 200 g/l of at least one surfactant; water to make up to one liter, but not less than 200 g/l; and optionally up to 200 g/l of at least one polar solvent which is at least partially soluble in water. The surfactant can, for example, be alkoxylated triglycerides such as ethoxylated castor oil, ethoxylated propoxylated castor oil; or alkoxylated sorbitan fatty esters.

Ultra low volume (ULV) endosulfan formulations generally do not contain water but do possess high-boiling point solvents. They are solvent/mineral based formulations generally comprising about 25% endosulfan and are designed to be applied neat by aerial application or small droplet applicators. One example of an ULV endosulfan formulation comprises (figures for 1 L of concentrate) about 242 g/L of technical grade endosulfan (99% purity), 3 g of alkyl phenol ethoxylate and 7 g of calcium dodecyl benzene sulfonate as emulsifiers, 10 g of epoxidised soybean oil as a stabiliser, and 350 ml of mineral oil and the balance being an aromatic hydrocarbon as solvents. Further examples of such formulations are provided in U.S. Pat. No. 3,952,102 and U.S. Pat. No. 3,996,375. U.S. Pat. No. 3,952,102 discloses an ULV endosulfan formulation comprising 60 to 84.5 weight % of a solvent mixture of 1.5 to 2.5 parts by weight of a vegetable oil consisting of rapeseed, cottonseed, peanut, sunflower, or safflower oil, and from 0.5 to 1.5 parts by weight of an aromatic hydrocarbon having a boiling range of from 170° C. to 250° C. consisting of one or more alkyl benzenes having 9 to 11 carbon atoms; or 1-or 2-methyl naphthalene; and from 0.5 to 6 weight % of an epoxide selected from the group consisting of epichlorohydrin, epoxypropane, styrene oxide, phenylepoxy propane, and an epoxide of an unsaturated vegetable oil.

Endosulfan formulations of the present invention can also take the form of an ultra low/emulsifiable concentrate (UL/EC). These formulations are solvent/mineral oil based and generally about 240 g/L endosulfan. They are designed to be applied neat or diluted with water by spray. An example of an endosulfan UL/IEC formulation comprises contain (figures for 1 L of concentrate) 242 g/L of technical grade endosulfan (99%0 purity), 30 g of alkyl phenol ethoxylate and 40 g of calcium dodecyl benzene sulfonate as emulsifiers, log of epoxidised soybean oil as a stabiliser, and 350 ml of mineral oil and the balance being an aromatic hydrocarbon as solvents.

Endosulfan formulations have also been prepared as microemulsions. These are stable, water based dispersions of two immiscible liquids with adjusted emulsifiers with little or no solvent. Microemulsions are diluted with water prior to spray. An example of an endosulfan microemulsion comprises (figures for 1 L of concentrate) about 35 3 g/L of technical grade endosulfan (99% purity), 20 g of polycarboxylate copolymer as a dispersant, log of nonionic ethoxylate as a wetting agent, 40 g of propylene glycol as an humectant, and 60 ml of aromatic hydrocarbon as a solvent, with the balance being water.

Wettable powders can contain between 15 and 50% active ingredient (technical) with clay and wetting agents as inert ingredients. The commercial product is diluted in water before spraying. An example of an endosulfan wettable powder formulation comprises (figures for 1 L of concentrate) about 505 g/L of technical grade endosulfan (99% purity), 20 g of polyalklaryl sulphonate or sodium (or calcium) lignosulfonate as a dispersant, log of nonionic ethoxylate as a wetting agent, with the balance being clay or talc.

An example of an aqueous suspension of endosulfan is provided in U.S. Pat. No. 4,804,399 which discloses a liquid pesticidal composition in the form of a concentrated aqueous suspension consisting essentially of 15 to 50% by weight endosulfan, an alkali metal salt of sulfosuccinic acid semiester prepared by reaction of a polyglycol ether of a condensation product of (C₈-C₁₂)-alkylphenol and formaldehyde with maleic anhydride and an alkali metal sulfite, and an alkali metal salt of a ligninsulfonic acid in admixture with identical parts of a swelling alkaline earth metal silicate. U.S. Pat. No. 5,753,591 also discloses an aqueous suspension endosulfan concentrate. In this case the formulation comprises endosulfan, a surfactant combination of a neutralized phosphoric ester based on an ethoxylated alkylphenol and an ethoxylated alkylaryl- and alcohol phosphate ester.

U.S. Pat. No. 5,653,973 provides an example of a bait for lepidopteran species comprising endosulfan.

The endosulfan formulations of the present invention can be encapsulated in microcapsules as generally described in U.S. Pat. No. 5,549,903 and U.S. Pat. No. 6,294,570.

The formulations of the present invention can be prepared by the same techniques currently used to prepare endosulfan pesticides with the exception of the increased amount of beta endosulfan when compared to alpha endosulfan. This higher ratio of beta to alpha endosulfan can be achieved by any technique known in the art. It can also be achieved by using the method of the sixth aspect of the present invention. Using this method, substantially pure formulations of beta endosulfan and alpha endosulfan can be obtained and mixed to the desired ratios.

Endosulfan formulations of the present invention will contain at least one acceptable carrier. Suitable carriers are well known to those skilled in the art, where the carrier(s) will depend upon the type of formulation. For instance, emulsified concentrates are diluted in water before use, whereas ULV formulations at least comprise a solvent.

The endosulfan formulations of the present invention can be applied to an area using the same techniques used with currently available endosulfan formulations. Liquid formulations can be applied by spraying (for example, aerial or boom spray) or by air blasting. Application rates vary considerably on the crop and target pest. Examples of application rates for cotton crops are approximately 3 L/ha for ULV formulations and 735 gai/ha for water in emulsion formulations.

### EXAMPLE 1

The method of separating a mixture of alpha and beta stereoisomers may include the following steps:

(a) providing a solution of commercial endosulfan being a mixture of alpha and beta endosulfan, in a solvent. The concentration of the solution depending on the solvent and the temperature of the solvent. For example, at a concentration of 20 g/L in 60-80 petroleum ether at 25° C.

(b) cooling said solution. The temperature of cooling depending on the solvent. For example, at −20° C. for a solution in 60-80 petroleum ether.

(c) separating the crystalline precipitate and supernatant solution.

(d) filtering the resultant crystalline precipitate and washing with the same cooled solvent to provide crystals of primarily beta-endosulfan.

(e) evaporating solvent from the residual supernatant solution to provide crystals of primarily alpha-endosulfan.

Beta endosulfan enrichment was also achieved in the following manner. Commercial endosulfan (70% alpha: 30% beta, 5 g) was added to refluxing hexane (25 ml) and sufficient dichloromethane was added gradually until the endosulfan had just dissolved. The solution was allowed to cool to room temperature then cooled further overnight in a freezer at −20 degrees. The crystals of beta-endosulfan were filtered and washed with a small volume of hexane. The residue from concentration of the supernatant mother liquor in a solvent evaporator comprised enriched alpha-endosulfan. A single recrystallisation of the beta-endosulfan crystals from dichloromethane-hexane (70:30) gave the purified isomer (99.5% beta; 0.5% alpha).

### EXAMPLE 2

Trials were conducted using beta-enriched formulations according to the invention which were compared with alpha-enriched formulations and commercial formulations (alpha to beta ratio 70:30). The trials were conducted to minic conditions that occur in the field.

The endosulfan formulations were prepared by diluting the following concentrate (figures for 1 L of concentrate) in water: 364 g/L of 96% technical grade endosulfan, 37 g of nonyl phenol ethoxylate, 33 g of 60% calcium dodecyl benzene sulfonate in 2-ethylhexanol with the balance being an aromatic solvent.

Results from this trial indicated that the beta-enriched formulation was approximately equally toxic to Helicoverpa in comparison to the commercial formulation over a nine-day period (FIG. 2). This experiment was performed using cotton plants under Australian field conditions in April, when mean daily maximal temperatures were 27.0° C. and mean daily minimal temperatures were 11.8° C. In Australia, endosulfan is used to control Helicoverpa in the warmer month of December (mean daily max. 32.9° C., min. 17.6° C.). It was predicted that the alpha-isomer would volatilise at a greater rate under these conditions and that its persistence on the cotton plant would be reduced as a result.

### EXAMPLE 3

A small plot replicated ground trial was conducted during the 2000/2001 cotton season to evaluate the efficacy of a 240 g a.i./L β-endosulfan formulation in comparison to the commercial product THIODAN (Aventis CropScience Pt7 Ltd—70:30 w/w alpha to beta endosulfan), for the control of Heliocoverpa spp. in cotton. The trial was conducted near Boggabri in the Namoi Valley of north-western New South Wales, Australia. The following treatments were evaluated in the trial:

| | |
|---|---|
| 1. β-endosulfan (95%), α-endosulfan (5%) | at 368 g ai/ha |
| 2. β-endosulfan (95%), α-endosulfan (5%) | at 735 g ai/ha |
| 3. THIODAN | at 735 g ai/ha |
| 4. Untreated control | |

The beta enriched formulations were prepared generally as described above in Example 2, however, as they only contained 240 g a.i./L, endosulfan, the extra volume was made up by additional aromatic solvent.

The trial was laid out using a randomised complete block design with four replicates. Plots were 6 m wide by 15 m long, with treatments applied to the centre two rows only. The treatments were applied twice, 7 days apart, using a 2 m wide boom spray. Assessment for Helicoverpa control were carried out prior to each treatment application and every 3 to 4 days after treatment application, until the treatments were reapplied or the trial was concluded.

Assessment was accomplished by counting the number of Helicoverpa eggs and larvae, and the number of damaged squares and bolls on 20 randomly selected cotton terminals per plot. The Helicoverpa population was 30% Heliocoverpa armigera at the commencement of the trial and over the duration of the trial the proportion of H. armigera increased. Leaf samples, consisting of approximately 200 g of leaf, were collected four and seven days after each treatment and analysed by gas chromatography/mass spectroscopy to determine relative levels of α-endosulfan, β-endosulfan and endosulfan sulfate.

All treatments provided equivalent and significant control of the Helicoverpa population present in the trial (FIGS. 3 and 4). No significant rate response was detected in the control provided by β-endosulfan enriched formulation as the application rate decreased from 735 g ai/ha to 368 g ai/ha.

Residue analyses found that the ratio of endosulfan sulfate to β-endosulfan residues increased over time in all leaf samples. However, the ratio was five times higher in leaves treated with THIODAN than in leaves treated with β-endosulfan (Table 3). This is in agreement with levels of endosulfan sulfate found in leaves of other plants after treatment with individual isomers (Chopra and Mahfouz, 1977; Mukherjee and Gopal, 1994). For instance, 14 days after treatment a-endosulfan treated tobacco plants contained 0.5 ppm endosulfan sulfate where as β-endosulfan treated plants contained 0.1 ppm of the toxic metabolite.

TABLE 3
Ratio of α-endosulfan:β-endosulfan:endosulfan sulfate
residues in cotton leaves treated with THIODAN
or β-endosulfan formulations.

| | 4 days after | 7 days after | 4 days after | 7 days after |
|---|---|---|---|---|
| Treatment | treatment 1 | treatment 1 | treatment 2 | treatment 2 |
| β-endosulfan¹ | 0:0:0 | 0:1:0 | 0.1:1:0.2 | 0:1:0.5 |
| enriched at | | | | |
| 368 g ai/ha | | | | |
| β-endosulfan¹ | 0.1:1:0 | 0.9:1:0 | 0.1:1:0 | 0.1:1:0 |
| enriched at | | | | |
| 735 g ai/ha | | | | |
| THIODAN at | 0.2:1:0.9 | 0:1:1.5 | 0.5:1:0.5 | 0:1:2.4 |
| 735 g ai/ha | | | | |

¹β-endosulfan (95%), α-endosulfan (5%).

The results of the field trial demonstrate equivalent efficacy of a β-endosulfan based formulation in comparison to the commercial formulation, and that lower application rates of a β-endosulfan based formulation provide equivalent control to the higher rates of application. The trial also demonstrated preferential conversion of α-endosulfan to endosulfan sulfate occurs with the current commercial formulation and that the use of a β-endosulfan based formulation reduces endosulfan sulfate residues in leaves.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

All publications discussed above are incorporated herein in their entirety.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### REFERENCES

Abalis, I. M., Eldefrawi, M. E. and A. T. Eldefrawi. 1985. High affinity stereospecific binding of cyclodiene binding insecticides and y-hexachlorocyclohexane to y-aminobuturic acid receptors of rat brain. Pestic. Biochem. Physiol. 24:95-102.

Abalis, I. M., Eldefrawi, M. E. and A. T. Eldefrawi. 1986. Effects of insecticides on GABA-induced chloride influx into rat brain microsacs. J. Toxicol. Environ. Health 18:13-23.

Archer, T. E., J. K. Nazer, and D. G. Crosby. 1972. Photodecomposition of endosulfan and related products by ultraviolet radiation. J. Agric. Food Chem. 20:954-956.

Archer, T. E. 1973. Residues on alfalfa hay exposed to drying by sunlight, ultraviolet light and air. Pesticide Science 4:59-68.

Barnes, W. W, and G. W. Ware. 1965. The absorption and metabolism of C14-labeled endosulfan in the housefly. J. Econ. Entomol. 58:286-291.

Beard, J. E., and G. W. Ware. 1969. Fate of endosulfan on plants and glass. J. Agr. Food Chem. 17:216-220.

Chopra, N. M., and A. M. Mahfouz. 1977. Metabolism of endosulfan I, endosulfan II, and endosulfan sulfate in tobacco leaf. J. Agric. Food Chem. 25:32-36.

Dorough, H. W., K. Huhtanen, T. C. Marshall, and H. E. Bryant. 1978. Fate of endosulfan in rats and toxicological considerations of apolar metabolites. Pest. Biochem. Physiol. 8:241-252.

Edge, V. E., Alhmad, N. and Rohas, P. 1998. Aerial transport of endosulfan: vapour and dust movement. Minimising the impact of pesticides on the riverine environment: key findings from research with the cotton industry—1998 conference. LWRRDC Occassional Paper 23/98, Can berra, ACT, April, 1998.

Ffrench-Constant, R. H. 1993. The molecular and population genetics of cyclodiene insecticide resistance. Insect Biochem. Molec. Biol. 24:335-345.

Gant, D. B., M. E. Eldefrawi, and A. T. Eldefrawi. 1987. Cyclodiene insecticides inhibit GABA receptor-regulated chloride transport. Toxicol. Appl. Pharmacol. 88:313-321.

Goebel, H., S. Gorbach, W. Knauf, R. H. Rimpau, and H. Huttenbach. 1982. Properties, effects, residues and analytics of the insecticide endosulfan. Residue Reviews. 83:40-41.

Kathpal, T. S., Singh, A., Dhankhar, J. S. and G. Singh. 1997. Fate of endosulfan in cotton soil under sub-tropical conditions in northern India. Pestic. Sci. 50:21-27.

Kennedy, I. R., Sanchez-Bayo, F., Kimber, S. W. L., Beasley, H. and N. Ahmad. 1998a. Movement and fate of endosulfan on-farm (New South Wales). Transport and fate of pesticides in cotton production systems—NSW field site and degradation study Final Milestone Report, LWRRDC, Can berra, ACT, April, 1998.

Kennedy, I. R., Ahmad, N., Tuite, J., Kimber, S., Sanchez-Boyer, F., Southan, S., Hugo, L., Wang, S., Lee, A., Beasley, H. and E. Wronski. 1998b. Minimising the impact of pesticides on the riverine environment: key findings from research with the cotton industry—1998 conference. LWRRDC Occassional Paper 23/98, Can berra, ACT, April 1998.

Lindquist, D. A. and Dahmi, P. A. 1972. Some chemical and biological experiments with Thiodan. J. Econ. Entomol. 50:483-487.

Mukherjee, I., and M. Gopal. 1994. Degradation of beta-endosulfan by Aspergiflus niger. Toxicol. Environ. Chem. 46:217-221.

Singh, N. C., T. P. Dasgupta, E. V. Roberts, and A. Mansingh. 1991. Dynamics of pesticides in tropical conditions. 1. Kinetic studies of volatilisation, hydrolysis and photolysis of dieldrin and alpha and beta-endosulfan. J. Agric. Food Chem. 39:575-579.

Sutherland, T. D., I. Home, M. J. Lacey, R. L. Harcourt, R. J. Russell, J. G. Oakeshott. 2000. Enrichment of an endosulfan-degrading mixed bacterial culture. Appl. Environ. Microbiol. 66:2822-2828.

Walfenbarger, D. A. and A. A. Guerra. 1972. Toxicity of endosulfan and its isomers to the bollworm and tobacco budworm. J. Econ. Entomol. 65:1122-1123.

1. A method for controlling or reducing pest numbers in an area affected or likely to be affected by pests, the method comprising applying to the area an endosulfan formulation, the formulation comprising beta endosulfan and alpha endosulfan, wherein the ratio of beta to alpha endosulfan in the formulation is at least 3.5:6.5 w/w.

2. The method of claim 1, wherein the formulation is an ultra low volume formulation.

3. The method of claim 2, wherein the ultra low volume formulation comprises a low volatility solvent.

4. The method of claim 3, wherein the low volatility solvent is selected from the group consisting of mineral oil, vegetable oil and aromatic hydrocarbons.

5. The method according to any one of claims 2 to 4, wherein the formulation further comprises an emulsifier.

6. The method of claim 5, wherein the emulsifier is selected from the group consisting of a nonionic surfactant and an anionic surfactant.

7. The method according to any one of claims 2 to 6, wherein the formulation further comprises a stabilizer.

8. The method of claim 7, wherein the stabilizer is epoxidised soybean oil.

9. The method of claim 1, wherein the formulation is an emulsifiable concentrate formulation.

10. The method of claim 9, wherein the emulsifiable concentrate formulation comprises an emulsifier and a solvent.

11. The method of claim 10, wherein the emulsifier is selected from the group consisting of a nonionic surfactant and an anionic surfactant.

12. The method of claim 10 or claim 11, wherein the formulation comprises an anionic surfactant and at least one nonionic surfactant.

13. The method according to any one of claims 9 to 12, wherein the solvent is an aromatic hydrocarbon.

14. The method according to any one of claims 9 to 13, wherein the emulsifiable concentrate formulation is mixed with water to produce an oil-in-water emulsion formulation.

15. The method of claim 1, wherein the formulation is a ultra low volume/emulsifiable formulation.

16. The method of claim 15, wherein the ultra low volume/emulsifiable formulation comprises an emulsifier and a low volatility solvent.

17. The method of claim 16, wherein the formulation further comprises a stabilizer.

18. The method according to any one of claims 1 to 17, wherein the air and/or ground temperature of the area to which the formulation is to be applied is at least 28° C.

19. The method according to claim 18, wherein the air and/or ground temperature of the area to which the formulation is to be applied is at least 35° C.

20. The method according to claim 18, wherein the air and/or ground temperature of the area to which the formulation is to be applied is at least 40° C.

21. The method according to any one of claims 1 to 20, wherein the ratio of beta to alpha endosulfan is at least 5:5 w/w.

22. The method according to any one of claims 1 to 20, wherein the ratio of beta to alpha endosulfan is at least 9:1 w/w.

23. The method according to any one of claims 1 to 20, wherein the ratio of beta to alpha endosulfan is at least 19:1 w/w.

24. The method according to any one of claims 1 to 23, wherein the endosulfan formulation is applied at less than 750 gai/ha.

25. The method of claim 24, wherein the endosulfan formulation is applied at less than 400 gai/ha.

26. The method according to any one of claims 1 to 25, wherein the pest is a species of Insecta or Acarina.

27. The method of claim 26, wherein the species of Insecta is selected from the group consisting of a lepidopteran, hemipteran, dipteran, hymenopteran, isopteran, homopteran, heteropteran, thysanopteran or coleopteran.

28. The method according to any one of claims 1 to 25, wherein the pest is a species of lepidopteran.

29. The method of claim 28, wherein the lepidopteran is Heliothis sp. or Helicoverpa sp.

30. The method of claim 26, wherein the species of Acarina is a mite.

31. A method for controlling or reducing pest numbers in an area affected or likely to be affected by pests, the method comprising applying to the area an endosulfan formulation, the formulation comprising beta endosulfan but no alpha endosulfan.

32. A method for controlling or reducing pest numbers in an area affected or likely to be affected by pests, the method comprising applying to the area an endosulfan formulation, the formulation comprising beta endosulfan and alpha endosulfan, wherein the ratio of beta to alpha endosulfan in the formulation is at least 3.5:6.5 w/w, and wherein at least some of the pests are resistant to endosulfan formulations wherein the ratio of beta to alpha endosulfan in the formulation is equal to or less than about 3:7 w/w.

33. A method for controlling or reducing pest numbers in an area affected or likely to be affected by pests, the method comprising applying to the area an endosulfan formulation, the formulation comprising beta endosulfan but no alpha endosulfan, wherein at least some of the pests are resistant to endosulfan formulations wherein the ratio of beta to alpha endosulfan in the formulation is equal to or less than about 3:7 w/w.

34. An endosulfan formulation, the formulation comprising beta endosulfan and alpha endosulfan, wherein the ratio of beta to alpha endosulfan in the formulation is at least 3.5:6.5 w/w.

35. The endosulfan formulation of claim 34, wherein the formulation is an ultra low volume formulation.

36. The endosulfan formulation of claim 35, wherein the ultra low volume formulation comprises a low volatility solvent.

37. The endosulfan formulation of claim 36, wherein the low volatility solvent is selected from the group consisting of mineral oil, vegetable oil and aromatic hydrocarbons.

38. The endosulfan formulation according to any one of claims 35 to 37, wherein the formulation further comprises an emulsifier.

39. The endosulfan formulation of claim 38, wherein the emulsifier is selected from the group consisting of a nonionic surfactant and an anionic surfactant.

40. The endosulfan formulation according to any one of claims 35 to 39, wherein the formulation further comprises a stabilizer.

41. The endosulfan formulation of claim 40, wherein the stabilizer is epoxidised soybean oil.

42. The endosulfan formulation of claim 34, wherein the formulation is an emulsifiable concentrate formulation.

43. The endosulfan formulation of claim 42, wherein the emulsifiable concentrate formulation comprises an emulsifier and a solvent.

44. The endosulfan formulation of claim 43, wherein the emulsifier is selected from the group consisting of a nonionic surfactant and an anionic surfactant.

45. The endosulfan formulation of claim 43 or claim 44, wherein the formulation comprises an anionic surfactant and at least one nonionic surfactant.

46. The endosulfan formulation according to any one of claims 42 to 45, wherein the solvent is an aromatic hydrocarbon.

47. The endosulfan formulation according to any one of claims 42 to 46, wherein the emulsifiable concentrate formulation is mixed with water to produce an oil-in-water emulsion formulation.

48. The endosulfan formulation of claim 34, wherein the formulation is a ultra low volume/emulsifiable formulation.

49. The endosulfan formulation of claim 48, wherein the ultra low volume/emulsifiable formulation comprises an emulsifier and a low volatility solvent.

50. The endosulfan formulation of claim 49, wherein the formulation further comprises a stabilizer.

51. The endosulfan formulation according to any one of claims 34 to 50, wherein the ratio of beta to alpha endosulfan is at least 5:5 w/w.

52. The endosulfan formulation according to any one of claims 34 to 50, wherein the ratio of beta to alpha endosulfan is at least 9:1 w/w.

53. The endosulfan formulation according to any one of claims 34 to 50, wherein the ratio of beta to alpha endosulfan is at least 19:1 w/w.

54. A method of enriching the beta endosulfan content of a mixture containing alpha endosulfan and beta endosulfan comprising:
(a) providing a solution of the mixture in a solvent;
(b) cooling the solution to a temperature at which at least part of the beta endosulfan precipitates to form a crystalline product comprising the precipitated beta endosulfan and a supernatant solution;
(c) separating the crystalline product from the supernatant solution; and
(d) optionally washing the crystalline product.

55. A method according to claim 54, wherein the ratio of beta endosulfan to alpha endosulfan in the mixture of step (a) is less than 1:1 w/w and the ratio of beta endosulfan to alpha endosulfan in the crystalline product in step (c) is at least 1:1 w/w.

56. A method according to claim 54, wherein the ratio of beta endosulfan to alpha endosulfan of the mixture in step (a) is about 3:7 w/w.

57. A method according to any one of claims 54 to 56, wherein the ratio of beta endosulfan to alpha endosulfan in the crystalline product of step (c) is at least 3.5:6.5 w/w.

58. A crystalline substance comprising beta endosulfan and alpha endosulfan in a ratio of at least 3.5:6.5 w/w.
